(19) United States
(12) Patent Application Publication
(10) Pub. No.: US 2011/0010200 A1
(43) Pub. Date: Jan. 13, 2011

(54) Patient and Physician Communication Tool

(76) Inventors: Kashif Firozvi, Potomac, MD (US); Nabeel Shamim, Morris Plains, NJ (US)

Correspondence Address: Rahman LLC, 10025 Governor Warfield Parkway, Suite 110, Columbia, MD, 21044, US

(21) Appl. No.: 12/834,446

(22) Filed: Jul. 12, 2010

Related U.S. Application Data
(60) Provisional application No. 61/225,175, filed on Jul. 13, 2009.

(51) Int. Cl. G06Q 50/00; G06F 17/30

(52) U.S. Cl. 705/3; 705/2; 707/769; 707/E17.014

(57) ABSTRACT

A method of performing communication between a healthcare provider and a patient by accessing a communication server includes a healthcare provider module, a patient module, and a database. The patient registers and accesses the patient module. The healthcare provider registers and accesses the healthcare provider module. The database includes information associated with the patient and the healthcare provider. The method includes processing an agreement of the patient to access a message from the database, providing a list of authorized individuals being granted permission to access the a messages from the database, communicating an identification code to the patient and to the authorized individuals, and displaying a mailbox interface associated with the patient module to the patient on the identification code being entered. The message is accessed on-demand from the patient module. The message is accessed by any of the patient and the authorized individuals.

### CROSS-REFERENCE TO RELATED APPLICATION

This application claims the benefit of U.S. Provisional Application No. 61/225,175 filed on Jul. 13, 2009, the complete disclosure of which, in its entirety, is herein incorporated by reference.

### BACKGROUND

1. Technical Field

The embodiments herein generally relate to communication systems, and, more particularly, to physician and patient communication system in hospitals.

2. Description of the Related Art

The healthcare system is growing in terms of complexity and level of sophistication in regards to the quality of care being administered to patients. There is a shortage of physicians on the national and international level, while the population of the country is growing especially in the geriatric population (the group that is most in need of medical care). Physicians work longer hours and have more demands put on them for their time.

One area of increasing frustration for patients is in the inability to effectively communicate with physicians. This is due to several reasons: (1) When patients are in the hospital, physicians round at hours outside of traditional visiting hours; i.e., when family members are not welcome. This saves time for physicians, but also adds to frustration for patients and their families, because they feel left out of the process and are unable to personally discuss matters with the physician. (2) Physicians feel overwhelmed by having to juggle their schedule in order to be available according to the time constraints of family and patients.

A recent McKinsey report shows that enhanced physician/patient communication is a significant need for patients when choosing a hospital. In this survey, 77% of those questioned said they would be willing to switch hospitals based on the hospital's ability to keep patients and patients' families informed of the status of their loved ones. Moreover, 100% of patients said it was the highest of priorities in choosing a hospital based on patient experience.

Typical experiences for physicians at hospitals are: A physician typically rounds between 6:00 AM-8:00 AM and makes decisions about patient care. Thereafter, the physician is generally busy performing procedures, meeting with patients, or attending to other matters related to his/her practice between 9:00 AM-6:00 PM. The physician has to sit down at the end of the day and communicate with patients and their families. Furthermore, the physician may round again late at night when no families are present (i.e., after visiting hours). With this process, families complain that they did not see their loved one's doctor once while in the hospital because the time when physicians can call and talk to patients is the time when family is not available or allowed to be present.

An ideal, yet impractical solution, would be as follows: (1) Physician comes to the hospital room to see the patient, and the family is there; (2) Physician answers all questions of both patient and family; (3) Physician then goes to his/her office and sees his patients there; (4) Physician calls back patients with lab results and talks to them directly and spends another 10-15 minutes with each patient. It is impossible for a doctor to communicate personally with each of their patient over the phone or in-person, due to the lack of hours in a day. Accordingly, there remains a need for an improved physician and patient communication experience.

### SUMMARY

In view of the foregoing, an embodiment herein provides a method of performing communication between a healthcare provider and a patient by accessing a communication server. The communication server includes a healthcare provider module, a patient module, and a database. The patient registers and accesses the patient module. The healthcare provider registers and accesses the healthcare provider module. The database includes information associated with the patient and the healthcare provider. The method includes processing an agreement of the patient to access a message from the database, providing a list of authorized individuals being granted permission to access the a messages from the database associated with the communication server, communicating an identification code to the patient and to the authorized individuals, and displaying a mailbox interface associated with the patient module to the patient on the identification code being entered. The message is accessed on-demand from the patient module. The message is accessed by any of the patient and the authorized individuals.

The patient communicates with the healthcare provider using any of a video message and a text message. The healthcare provider communicates with any of the patient and the authorized individuals using any of a video message and a text message. The healthcare provider sends the message to the patient through a video input mechanism operatively connected to any of a portable and stationary communication device. The patient sends and receives the message to or from a plurality of healthcare providers. The patient communicates the messages to the healthcare provider using at least one of a portable and stationary communication device.

The communication server provides a forum for the healthcare provider to communicate with any of the patient, the authorized individuals, and other healthcare providers in real time. The forum includes video conferencing, means for searching the other healthcare providers by at least one of a name and a keyword associated with the other healthcare providers, and means for obtaining second opinions from the other healthcare providers. The healthcare provider engages with the other healthcare providers, the patient, and the authorized individuals through the communication server.

The communication server allows for any of the patient, the healthcare provider, and the authorized individuals to search for a particular disease in the database. The communication server integrates electronic medical records (EMR) of the patient to allow the healthcare provider, the patient, and the authorized individuals access records and schedules associated with the EMR. The messages are integrated with personal health records (PHR) associated with the patient and the healthcare provider. The communication server communicates healthcare provider approved records of the patient at a hospital. The patient accesses the healthcare provider approved records.

In another aspect, a program storage device readable by computer, and including a program of instructions executable by the computer to perform a method of performing communication between a healthcare provider and a patient by accessing a communication server is provided. The communication server includes a healthcare provider module, a patient module, and a database. The patient registers and accesses the patient module. The healthcare provider registers and accesses the healthcare provider module. The database includes information associated with the patient and the healthcare provider.

The method includes processing an agreement of the patient to access a message from the database, providing a list of authorized individuals being granted permission to access the messages from the database associated with the communication server, communicating an identification code to the patient and to the authorized individuals, and displaying a mailbox interface associated with the patient module to the patient on the identification code being entered. The message is accessed on-demand from the patient module. The message is accessed by any of the patient and the authorized individuals.

The patient communicates with the healthcare provider using any of a video message and a text message. The healthcare provider communicates with any of the patient and the authorized individuals using any of a video message and a text message. The healthcare provider sends the message to the patient through a video input mechanism operatively connected to any of a portable and stationary communication device. The patient sends and receives the message to or from a plurality of healthcare providers. The patient communicates the messages to the healthcare provider using at least one of a portable and stationary communication device. The communication server provides a forum for the healthcare provider to communicate with any of the patient, the authorized individuals, and other healthcare providers in real time.

The forum includes video conferencing, means for searching the other healthcare providers by at least one of a name and a keyword associated with the other healthcare providers, and means for obtaining second opinions from the other healthcare providers. The healthcare provider engages with the other healthcare providers, the patient, and the authorized individuals through the communication server. The communication server allows for any of the patient, the healthcare provider, and the authorized individuals to search for a particular disease in the database.

The communication server integrates electronic medical records (EMR) of the patient to allow the healthcare provider, the patient, and the authorized individuals access records and schedules associated with the EMR. The messages are integrated with personal health records (PHR) associated with the patient and the healthcare provider. The communication server communicates healthcare provider approved records of the patient at a hospital. The patient accesses the healthcare provider approved records.

In yet another aspect, a communication tool is provided. The communication tool includes a healthcare provider module accessible by at least one healthcare provider that is registered to access the healthcare provider module, a patient module accessible by at least one of a patient and authorized individuals that is registered to access the patient module. Any of the patient and the authorized individuals access the patient module using an identification code to access the patient module. The healthcare provider module provides means for inputting healthcare provider messages and receiving any of patient messages and authorized user messages.

The patient module provides means for receiving the healthcare provider messages and inputting any of patient messages and authorized user messages. The patient communicates with the healthcare provider using any of a video message and a text message. The healthcare provider communicates with any of the patient and the authorized individuals using any of a video message and a text message. The healthcare provider sends the message to the patient through a video input mechanism operatively connected to any of a portable and stationary communication device.

The patient sends and receives the message to or from a plurality of healthcare providers. The patient communicates the messages to the healthcare provider using at least one of a portable and stationary communication device. The communication tool further includes a communication server operatively connected to the healthcare provider module and the patient module. The communication server provides a forum for the healthcare provider to communicate with any of the patient, the authorized individuals, and other healthcare providers in real time.

The forum includes video conferencing, means for searching the other healthcare providers by at least one of a name and a keyword associated with the other healthcare providers, and means for obtaining second opinions from the other healthcare providers. The healthcare provider engages with the other healthcare providers, the patient, and the authorized individuals through the communication server. The communication server allows for any of the patient, the healthcare provider, and the authorized individuals to search for a particular disease in the database.

The communication server integrates electronic medical records (EMR) of the patient to allow the healthcare provider, the patient, and the authorized individuals access records and schedules associated with the EMR. The patient messages are integrated with personal health records (PHR) associated with the patient and the healthcare provider. The communication server communicates healthcare provider approved records of the patient at a hospital. The patient accesses the healthcare provider approved records.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 illustrates a system view of patients communicating with Communication Server through a network using a communication device according to an embodiment herein;

FIG. 2 illustrates an exploded view of the Communication Server of FIG. 1 according to an embodiment herein;

FIG. 3 illustrates a user interface view of the patients registering at the patient module of the Communication Server of FIG. 1 according to an embodiment herein;

FIG. 4A and FIG. 4B illustrate user interface views of the patient module of FIG. 2 of the Communication Server of FIG. 1 after the registration according to an embodiment herein;

FIG. 5 illustrates a user interface view of the healthcare provider module of FIG. 2 of the Communication Server of FIG. 1 according an embodiment herein;

FIG. 6 illustrates a table view of the database of the Communication Server of FIG. 1 of the physicians of FIG. 1 according to first embodiment herein;

FIG. 7 illustrates a table view of the database of the Communication Server of FIG. 1 of the patients of FIG. 1 according to second embodiment herein;

FIG. 8 illustrates a schematic diagram of a computer architecture used in accordance with the embodiment herein; and

FIG. 9 is a flow diagram illustrating a method of performing communication between a healthcare provider and a patient by accessing a communication server according to an embodiment herein.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

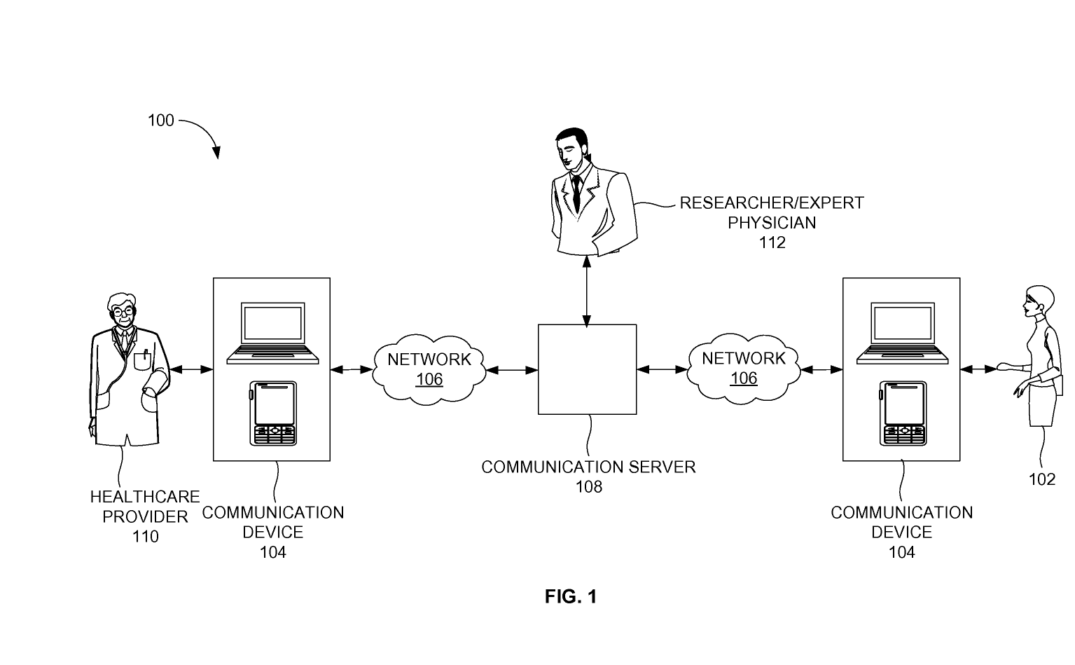

As mentioned, there remains a need for an improved physician and patient communication experience. The embodiments herein achieve this by providing a Communication Server where healthcare providers are registered to a healthcare provider module and patients are registered to a patient module associated with the communication server. The healthcare providers and the patients communicate with each other via video messages or text messages, etc. Referring now to the drawings, and more particularly to FIGS. 1 through 9, where similar reference characters denote corresponding features consistently throughout the figures, there are shown preferred embodiments.

FIG. 1 illustrates a system view 100 of a patient 102 communicating with a healthcare provider 110 via a Communication Server 108 through a network 106 using a communication device 104 according to an embodiment herein. The patient 102 registers with the communication server 108 using identifying information. The system view 100 further includes a researcher/expert physician 112. The patient 102 is then provided with an identification code to access the communication 108. In one embodiment, the identification code may be provided to family members associated with patient 102. The patient 102 accesses the communication server 108 using the communication device 104.

In one embodiment, the communication device 104 may be a personal computer, a mobile communication device (e.g., PDA), etc., although other communication devices may be used in accordance with the embodiments herein, and the embodiments herein are not restricted to a particular type of communication device 104. The patient 102 or the family members may send video messages or text messages (e.g., an email, MMS message, etc.) to the healthcare provider 110 for an inquiry. The healthcare provider 110 responds to the inquiry received from the patient 102 by logging on to the communication server 108. In one embodiment, the healthcare provider may be a physician. In another embodiment, the healthcare provider 110 may respond to the patient 102 inquiry via a video conferencing in real time or by sending a text message. In yet another embodiment, the healthcare provider 110 may consult a researcher/expert physician 112 for a second opinion. In one embodiment, the consultation may be a video conferencing, engaging interviews, or an e-mail in real time, etc. over the communication server 108.

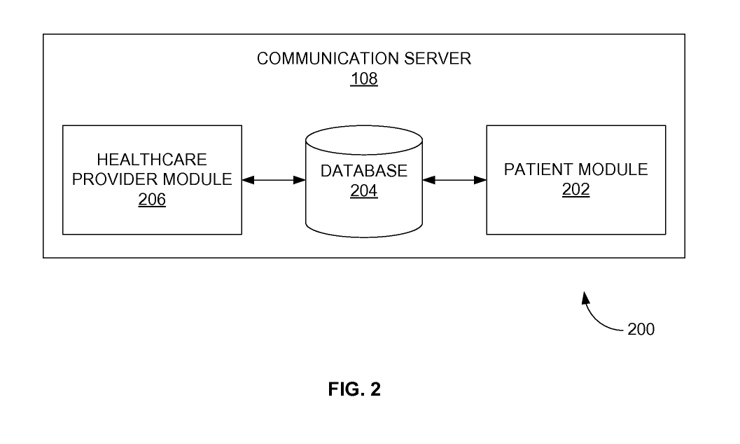

FIG. 2, with reference to FIG. 1, illustrates an exploded view 200 of the communication server 108 of FIG. 1 according to an embodiment herein. The exploded view 200 of the communication server 108 includes a patient module 202, a database 204, and a healthcare provider 206. The patient module 202 provides a list of individuals to the patient 102 who are granted permissions to access messages. When the patient 102 enters the identification code into the patient module 202 associated with the communication server 108, the patient 102 is then directed to his/her mailbox page where stored, on-demand video messages are available for viewing. In one embodiment, the on-demand video messages may also be viewed by friends or family members associated with the patient 102.

The database 204 includes information associated with the healthcare provider 110 and the patient 102. The patient 102 or the friends/family members of the patient 102 may send video messages or text messages (e.g., e-mail, etc.) to the healthcare provider 110. In one embodiment, the video message is sent by an inpatient to the healthcare providers 110 through a video camera that is located at the hospital workstations or in rooms. In another embodiment, the inpatient is one of the patients 102 who are registered to the patient module 202 associated with the communication server 108. The healthcare provider module 206 allows the healthcare provider 110 to view an inquiry received from the patient 102 and respond to the patient's inquiry.

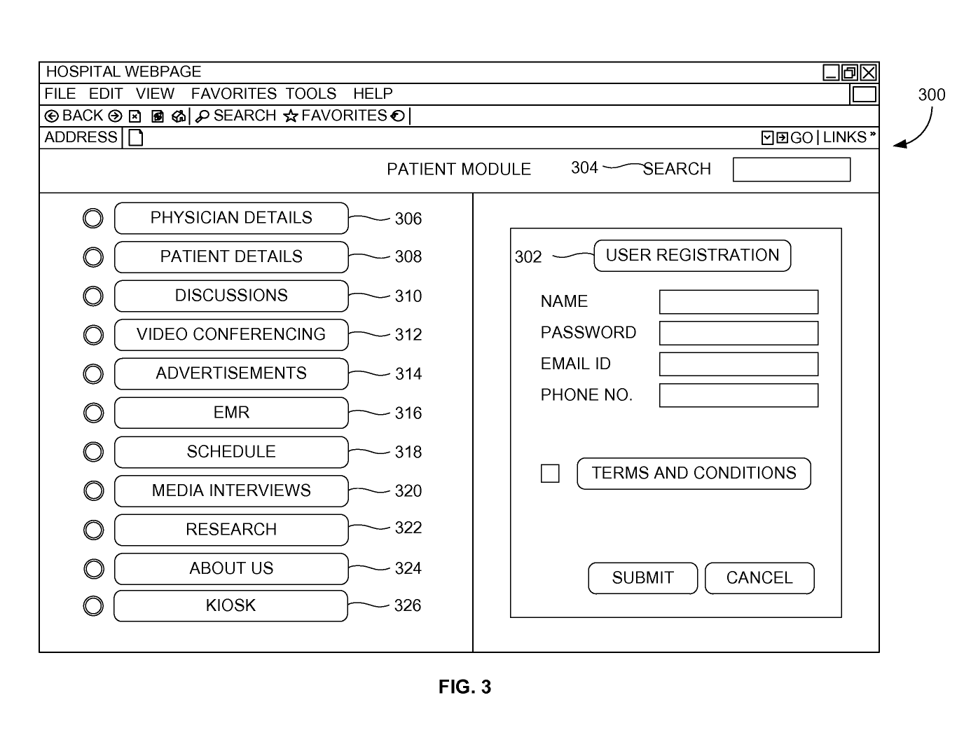

FIG. 3, with reference to FIGS. 1 and 2, illustrates a user interface view 300 of a patient 102 registering at the patient module 202 of the communication server 108 according to an embodiment herein. The user interface view 300 of the patient module 202 includes a user registration field 302, a search field 304, a physician details field 306, a patient details field 308, a discussions field 310, a video conferencing field 312, an advertisements field 314, an Electronic Medical Records (EMR) field 316, a schedule field 318, a media interviews field 320, a research field 322, an about us field 324, and a kiosk field 326. The user registration field 302 provides options (e.g., a name field, a password field, an e-mail ID field, a contact number field, etc.) to the users (e.g., patient 102 or friends/family members) to enter the corresponding details. The user (or the patient 102) registers with the patient module 202 of the PPCS 108 by entering the personal details and by agreeing to terms and conditions. The patient 102 is then provided with an identification code to access messages on the patient module 202 upon registering with the patient module 202.

The search field 304 allows the user (or patient 102 or friends/family member) to search with a particular keyword (e.g., such as a physician name, or researcher name, or disease type, etc.). The physician details field 306 provides the details of all the physicians (or the healthcare providers 110 of FIG. 1) associated with the communication server 108. In one embodiment, the physician details field 306 may display a list of physicians (or the healthcare providers 110 of FIG. 1) that are associated in communication with the patient 102. The patient details field 308 displays all the records/details associated with that particular patient and his/her user profile. The discussions field 310 may display on-demand and/or ongoing discussions on the patient 102 and his/her disease.

The video conferencing field 312 displays an option to have a video conference with the healthcare provider 110 for receiving a response to an inquiry. The advertisements field 314 may display advertisements of a pharmaceutical company, medical device, care facility, or a drug that is of interest to the patient 102 based on his/her profile and depending on the disease with which the patient 102 is inflicted. The Electronic Medical Records (EMR) field 316 displays all the medical records (e.g., scanning, ECG, etc.) of the patient 102. The schedule field 318 displays various meetings or real time video conferencing with the healthcare provider 110. The media interviews field 320 may display the healthcare provider 110 engaging interviews with the researcher 112 or an expert physician for a second opinion. The research field 322 may display the case studies of any patients 102 that are experimented/or studied by the healthcare providers and the expert physicians 110, 112. The about us field 324 may display brief details of the communication server 108 and the activities that are carried out. The user interface view of the patient module 202 may further include a kiosk field 326 where the patient 102 may download the healthcare provider-approved records of patient 102.

With reference to FIGS. 1 through 3, FIG. 4A and FIG. 4B illustrate succeeding views of a user interface view 400 of the patient module 202 of the communication server 108 after the registration according to an embodiment herein. The user interface views 400 of the patient module 202 includes a patient login details field 402, a submit field 404, and a cancel field 406.

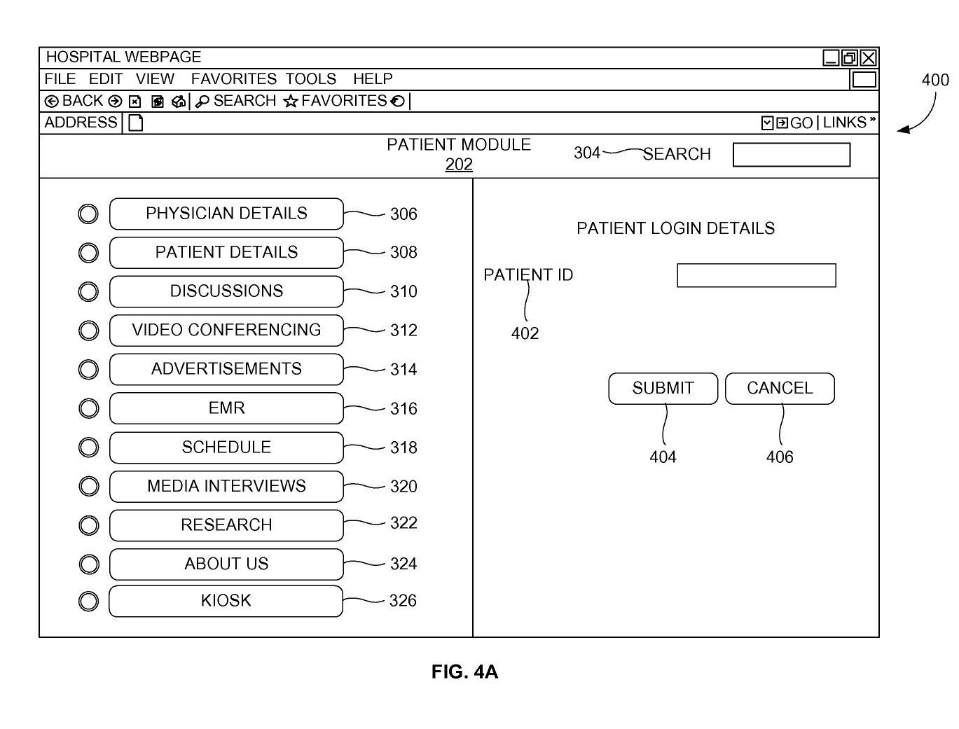

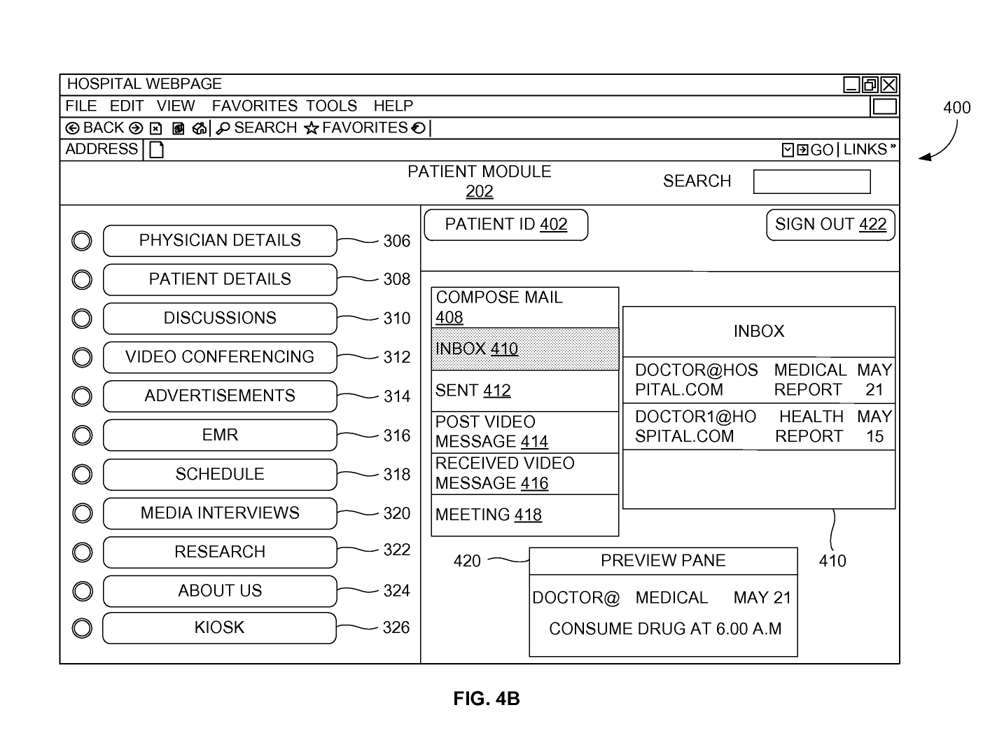

The patient login details field 402 allows the patient 102 or the friends/family members associated with the patient 102 to enter the patient identification code that is provided after registering to the patient module 202 and is affected by clicking the submit button 404. A cancel button 406 may be used to cancel the login procedures. The user interface view 400 of the patient module 202 as shown in FIG. 4B of the communication server 108 allows the patient 102 to view his/her mailbox after logging into the patient module 202 by entering the identification code associated with the particular patient 102. The patient 102 may now send video messages, text messages, etc. to the physician 110 and/or to the researcher 112 for an inquiry.

The patient 102 can also receive video messages, and/or text messages from the healthcare provider 110. The user interface view 400 of patient module 202 of FIG. 4B includes a mailbox interface that includes a compose mail field 408, an inbox field 410, a sent field 412, a post video message field 414, a received video message field 416, a meeting field 418, a preview pane field 420, and a sign out field 422. The compose mail field 408 allows the patient 102 or the friends/family members of the patient 102 to send an electronic communication to the healthcare providers 110. Similarly, the inbox field displays the communications (e.g., e-mails, text messages, etc.) received from the healthcare provider 110 or the researcher 112.

The sent field 412 displays the messages sent by the patient 102 to the healthcare provider 110 or the researcher 112. The post video message field 414 allows the patient 102 or the friends/family members of the patient 102 to record a video and send a video message to the healthcare provider 110. The received video message field 416 may display the video messages received from the healthcare provider 110 or the researcher 112. The meeting field 418 displays the records of meeting of the patient 102 with the healthcare provider 110 that occurred in real time. The preview pane field 420 displays a preview of any of the activities performed by the patient 102 on the any of the fields (e.g., fields 408-418).

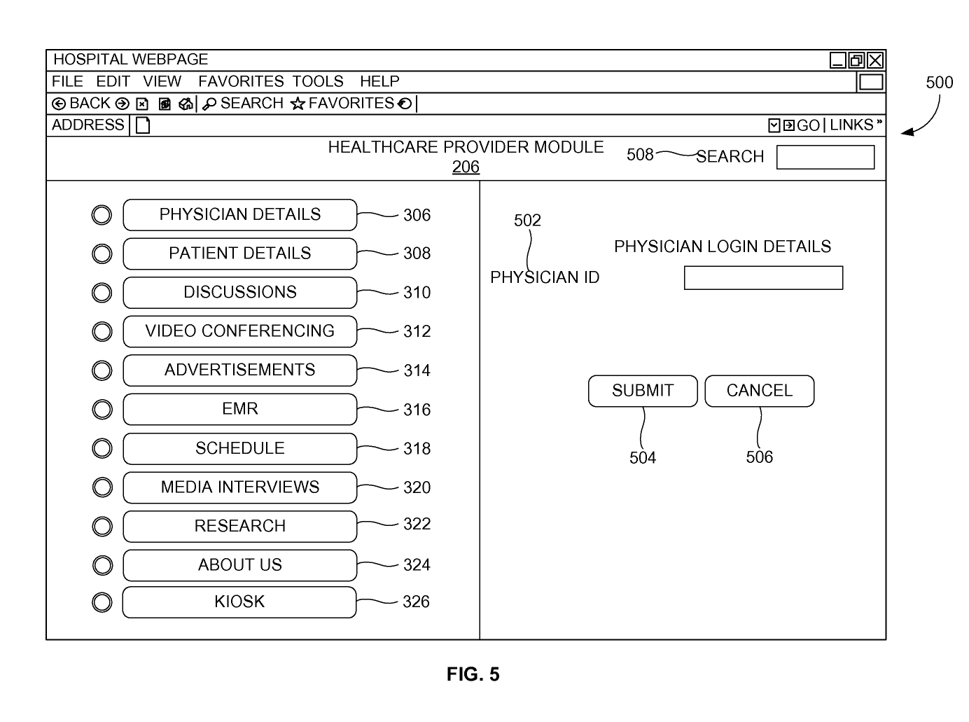

FIG. 5, with reference to FIGS. 1 through 4B, illustrates a user interface view 500 of the healthcare provider module 206 of the communication server 108 according an embodiment herein. The user interface view 500 of the healthcare provider module 206 includes a physician ID field 502, a submit field 504, a cancel field 506, and a search field 508. The physician ID field 502 allows the physician/ healthcare provider 110 to enter his/her ID and submit the ID by clicking on the submit button 504. The healthcare provider 110 is provided with a similar user interface view of the mailbox as shown in FIG. 4A and FIG. 4B. The search field 508 allows the healthcare provider 110 to search for a keyword, or a patient 102, or any data associated with the patient's medical records.

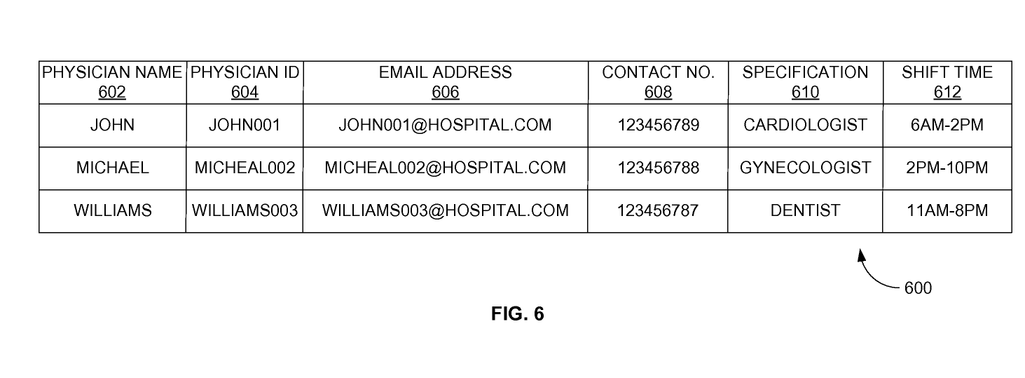

FIG. 6, with reference to FIGS. 1 through 5, illustrates a table view 600 of the database 204 of the communication server 108 according to first embodiment herein. The database 204 includes a physician name field 602, a physician ID field 604, an email address field 606, a contact number field 608, a specification field 610, and a shift time field 612. The physician name field 602 includes the names of the physicians/healthcare providers 110 (e.g., John, Michael, William, etc.) that are engaged in activities and communication with the patient 102. The physician ID field 604 includes the corresponding ID's associated with the physician/healthcare provider 110 (e.g., John ID is John001, Michael ID is Michae1002, and William ID is William003).

The email address field 606 includes corresponding email address associated with the healthcare provider 110. The contact number field 608 includes the contact information (e.g., 123456789 of John, 123456788 of Michael, 123456787 of William) of the physician/healthcare provider 110. In one embodiment, the patient 102 may directly contact the physician/healthcare provider 110 by calling the contact number. The specification field 610 displays the specialization of the physician/healthcare provider 110. For example, John is a cardiologist, Michael is a Gynecologist, and William is a dentist. The shift time field 612 displays the visiting timings of the healthcare provider/physician 110 to the patient's rooms, or workstations. For example, John visits his patients between 6:00 AM-2:00 PM, Michael visits his patients between 2:00 PM-10:00 PM, and William visits his patients between 11:00 AM-8:00 PM.

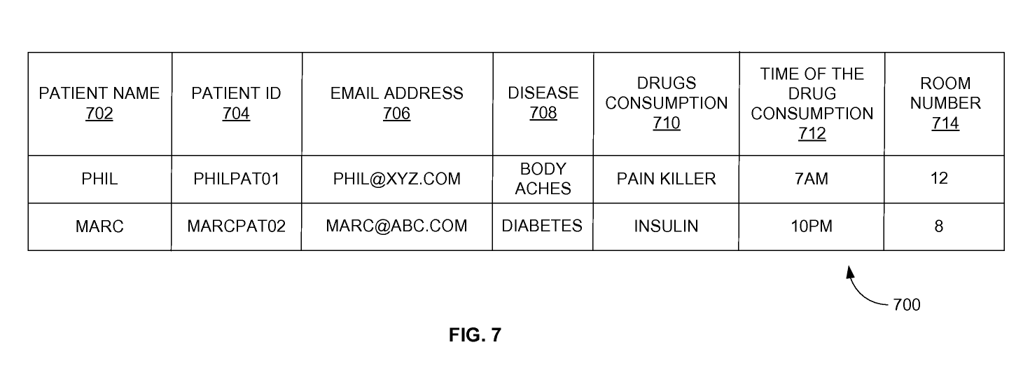

FIG. 7, with reference to FIG. 1 through 6, illustrates a table view 700 of the database 204 of the communication 108 according to second embodiment herein. The database 204 includes a patient name field 702, a patient ID field 704, an e-mail address field 706, a disease field 708, a drugs consumption field 710, a time of drug consumption field 712, and a room number field 714. The patient name field 702 includes name of the patients 102 (e.g., Phil and Marc). The patient ID field 704 includes patient ID's (e.g., Philpat01, and Marcpat02) which are issued at the time of registering to the patient module 202 of communication server 108 of FIG. 1.

The e-mail address field 706 includes the e-mail ID's (e.g., Phil@xyz.com, and Marc@abc.com) of the corresponding patient 102 (e.g., Phil and Marc). The disease field 708 indicates the disease with which the patient 102 is afflicted. For example, Phil suffers from body aches and Marc suffers from diabetes. The drugs consumption field 710 indicates the type of drugs (or specific drugs) that are to be consumed by the patients 102. For example, Phil takes painkiller drugs for body ache, and Marc takes insulin for diabetes. The time of drugs consumption field 712 indicates the time of the drug consumed by the patient 102 (e.g., Phil and Marc). For example, Phil takes the painkiller at 7:00 AM and Marc takes insulin at 10:00 PM. The room number field 714 indicates the room number that is allotted or being occupied by the patient 102 (e.g., Phil is occupied in Room No. 12, and Marc is occupied in Room No. 8).

The techniques provided by the embodiments herein may be implemented on an integrated circuit chip (not shown). The chip design is created in a graphical computer programming language, and stored in a computer storage medium (such as a disk, tape, physical hard drive, or virtual hard drive such as in a storage access network). If the designer does not fabricate chips or the photolithographic masks used to fabricate chips, the designer transmits the resulting design by physical means (e.g., by providing a copy of the storage medium storing the design) or electronically (e.g., through the Internet) to such entities, directly or indirectly.

The stored design is then converted into the appropriate format (e.g., GDSII) for the fabrication of photolithographic masks, which typically include multiple copies of the chip design in question that are to be formed on a wafer. The photolithographic masks are utilized to define areas of the wafer (and/or the layers thereon) to be etched or otherwise processed. The resulting integrated circuit chips can be distributed by the fabricator in raw wafer form (that is, as a single wafer that has multiple unpackaged chips), as a bare die, or in a packaged form. In the latter case the chip is mounted in a single chip package (such as a plastic carrier, with leads that are affixed to a motherboard or other higher level carrier) or in a multichip package (such as a ceramic carrier that has either or both surface interconnections or buried interconnections).

In any case the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a central processor.

The embodiments herein can take the form of an entirely hardware embodiment, an entirely software embodiment or an embodiment including both hardware and software elements. The embodiments that are implemented in software include but are not limited to, firmware, resident software, microcode, etc.

Furthermore, the embodiments herein can take the form of a computer program product accessible from a computer-usable or computer-readable medium providing program code for use by or in connection with a computer or any instruction execution system. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

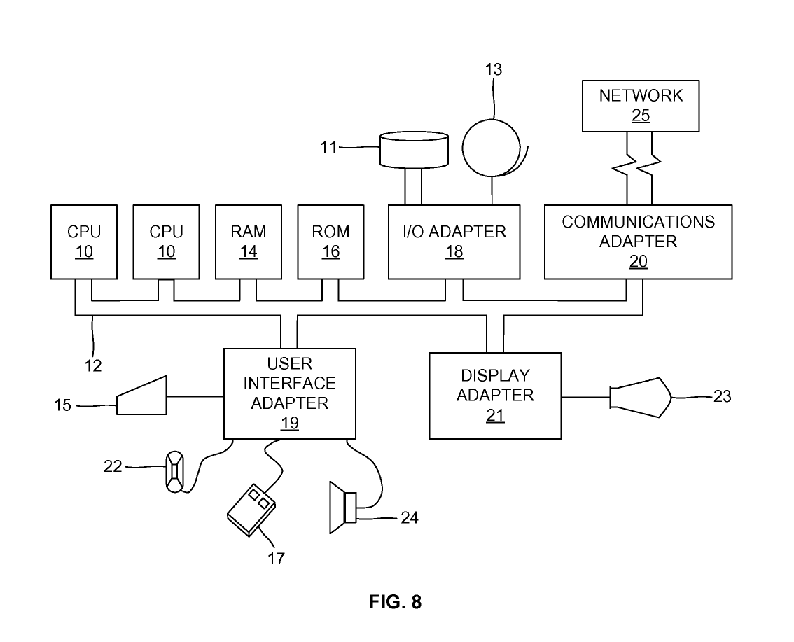

A representative hardware environment for practicing the embodiments herein is depicted in FIG. 8. This schematic drawing illustrates a hardware configuration of an information handling/computer system in accordance with the embodiments herein. The system comprises at least one processor or central processing unit (CPU) 10. The CPUs 10 are interconnected via system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of the embodiments herein.

The system further includes a user interface adapter 19 that connects a keyboard 15, mouse 17, speaker 24, microphone 22, and/or other user interface devices such as a touch screen device (not shown) to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

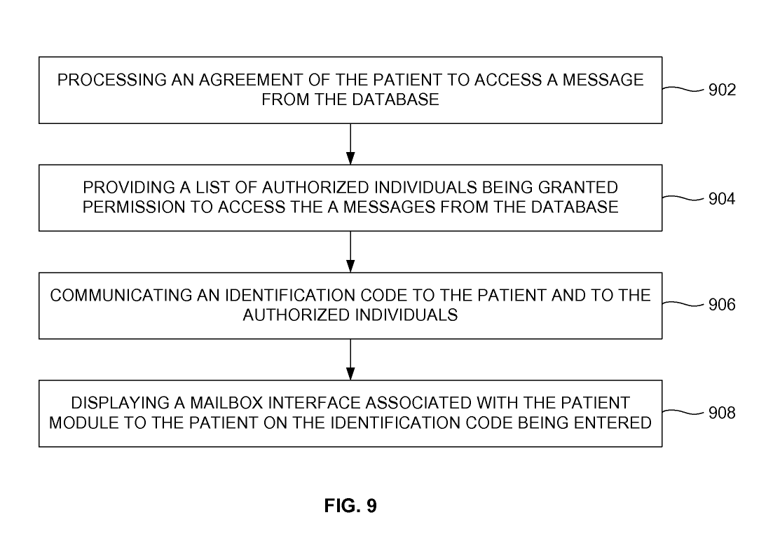

FIG. 9, with reference to FIGS. 1 through 8, is a flow diagram illustrating a method of performing communication between a healthcare provider 110 of FIG. 1 and a patient 102 by accessing a communication server 108 according to an embodiment herein. The communication server 108 includes a healthcare provider module 206 of FIG. 2, a patient module 202 of FIG. 2, and a database 204 of FIG. 2. The patient 102 registers and accesses the patient module 202. The healthcare provider 110 registers and accesses the healthcare provider module 206. The database 202 includes information associated with the patient 102 and the healthcare provider 110.

In step 902, an agreement of the patient 102 is processed to access a message from the database 204. In step 904, a list of authorized individuals being granted permission is provided to the patients 102 to access the messages from the database 204 associated with the communication server 108. In step 906, an identification code is communicated to the patient 102 and to the authorized individuals. In step 908, a mailbox interface associated with the patient module 202 is displayed to the patient 102 on the identification code being entered. The message is accessed on-demand from the patient module 202. The message is accessed by any of the patient 102 and the authorized individuals.

Further, the patient 102 communicates with the healthcare provider using any of a video message and a text message. The healthcare provider 110 communicates with any of the patient 102 and the authorized individuals using any of a video message and a text message. The healthcare provider 110 sends the message to the patient 102 through a video input mechanism operatively connected to any of a portable and stationary communication device 104. The patient 102 sends and receives the message to or from a plurality of healthcare providers 110. The patient 102 communicates the messages to the healthcare provider 110 using at least one of a portable and stationary communication device 110.

The communication server 110 provides a forum (e.g., a website) for the healthcare provider 110 to communicate with any of the patient 102, the authorized individuals, and other healthcare providers 110 in real time. The forum includes video conferencing, means for searching the other healthcare providers 110 by at least one of a name and a keyword associated with the other healthcare providers 110, and means for obtaining second opinions from the other healthcare providers 110. The healthcare provider 110 engages with the other healthcare providers 110, the patient 102, and the authorized individuals through the communication server 108.

The communication server 108 allows for any of the patient 102, the healthcare provider 110, and the authorized individuals to search for a particular disease in the database 202. The communication server 108 integrates electronic medical records (EMR) of the patient 102 to allow the healthcare provider 110, the patient 102, and the authorized individuals access records and schedules associated with the EMR. The messages are integrated with personal health records (PHR) associated with the patient 102 and the healthcare provider 110. The communication server 108 communicates healthcare provider approved records of the patient at a hospital. The patient 102 accesses the healthcare provider approved records.

The embodiments herein provide an alternative to the typical/conventional physician/patient communication experience and an alternative to the ideal/impractical solution in accordance with the embodiments herein: (1) For a hospital encounter, a physician 110 rounds and sees patients 102, then the physician 110 dictates a treatment plan for each patient 102 he sees into videophone or other similar input device (such as communication device 104), and then when the patient's friends/family arrives, they have a means of retrieving the video message of the physician 110 and see/hear status updates of the patient 102. In this scenario, friends/family members do not have to be local as they can remotely access the physician's message if given permission from the patient 102. (2) For an outpatient encounter, a physician 110 reviews lab reports, sends a message into videoconference, and then electronically signs off so that the message goes directly to the patient's e-mail inbox 410. The patient 102 can then retrieve each message and view/hear. At the end of day, the physician 110 can answer all messages without having to talk directly to the patient 102 and friends/family by leaving a message into system 100, thus saving the physician's time and making sure all patients 102 and/or friends/family have their questions answered.

The embodiments herein may be embodied in a computerized interactive database system 100, which may be accessible in either an internet or intranet system or a combination thereof, and may be accessible through a website. In one embodiment, information provided on the website is encoded with proper data security encryption to fulfill the highest and most stringent HIPAA regulations. The system 100 comprises a registration site, where a patient 102 registers via the hospital to provide access to site. The physician 110 also registers through the hospital to provide access to site. Entities other than the patient 102 and physician 110 may have access to the system 100, however it is either the patient 102 or physician 110 or a combination of both who determines access rights by other entities.

The patient portal/module 202 may be configured according to inpatient, inbox, and outpatient categories. In the inpatient category, an individual patient 102 can agree to terms and regulations of video access. The patient 102 also provides a list of individuals who are granted permission to access messages. An identification (ID) code 402 is given to the patient 102 and to friends/family members (if permitted). In the inbox category, upon entering the ID number 402, the patient 102 is sent to an inbox page 410 where stored on-demand video messages are available for viewing for a predetermined period of time (for example, 48 hours). This can be viewed by the patient 102 who is in hospital who wants to review the stated treatment plan. The message can also be viewed by the patient's assigned friends/family members (if permitted) from a website. In the outpatient category, patients 102 who have access to the website are able to send video messages or e-mails or texts, etc. to the physician 110. The physician 110 logs on to the website and can leave video messages or e-mails for patient 102 in response to an inquiry.

The physician portal/module 206 may be configured whereby access is granted by the hospital which performs all screening and authentication of identity of users. Here, the physician 110 accepts all terms and regulations of the video application. In the inpatient category, the physician 110 can leave video messages to patients 102 and friends/family members. The video message is presented via a videocam or similar mechanism that is located either on hospital workstations or in the patient's room or exam room or in other pre-designated locations. The physician 110 can leave e-mail that is available to other physicians 112 when they log onto the hospital site. In the outpatient category, a video message can be entered from the physician's office or from home. E-mail can be left from the physician's home or office. Data entry occurs via portable webcams from personal computers or hospital computers or handheld devices (e.g., communication device 104) that may be located anywhere. E-mail, texting, or chatting occurs from any computer or communication device 104.

The embodiments herein further provide physician-physician communication as well because in conventional systems time is wasted trying to get in touch with each referring doctor so much so that physicians often don't communicate with each other as they should. In this regard, physicians work on such different schedules, that it is often impossible to coordinate time to talk with one another. Accordingly, the system 100 provided by the embodiments herein, which may be embodied as a webpage, provide a means where physicians/healthcare providers 110, 112 can communicate with each other through a communication network 106. In a real-time environment, the embodiments herein provide video-conferencing, and also allow patients 102 and physicians/healthcare providers 110 to search 304 for physicians using names, key terms, (oncologists, etc.) as well as using other query terms. Additionally, the embodiments herein provide a mechanism for getting second opinions from experts 112 located all over the world and to provide/perform collaboration in research. Additionally, the embodiments herein can be used to get assistance from across the world in the operating room.

Furthermore, the embodiments herein function in a cyber-time (on-demand) environment. Video messages can be left for other physicians/healthcare providers 110, 112, who will receive the messages when they log on the system 100. The messages can also contain advertisements 314 for services/products. Additionally, the embodiments herein facilitate a means to perform conferences (for example, general, multidisciplinary, and specialty conferences) and discuss prescriptions using appropriate information technology software to perform interactions. Inpatient communications can link to hospital electronic medical record (EMR) systems 316 and allow for receiving second opinions from other physicians or experts 112.

Examples of patient-physician communications can occur using hospital communications, on-demand video conferencing, real-time family meetings and conferencing, and a second opinion clinic. Additionally, the embodiments herein may be configured for nurse-to-nurse communications where messages can be left for nurses on different shifts, where webpage signout occurs after shifts to further ensure system security. In patient-to-physician communications, the embodiments herein support group discussions, and the ability to search the database 204 for keyword disease types. Another example of implementation of the embodiments herein is physician-to-media communications where live interviews can be performed with expert physicians 112 or with patients 102 via a website. Another example of implementation of the embodiments herein is for scientists and the pharmaceutical industry, where cross-continent collaborations can occur with researchers 112 in certain fields, and also pharmaceutical companies can perform direct consumer advertising 314. This further allows the ability for pharmaceutical companies to data mine for patient information and prescription drug use. In this context, initial registration into the system 100 provides security and validation of data accuracy. Security measures may be incorporated into the system 100 to comply with privacy rules, standards, and patient 102 desire.

Several different technology applications may be utilized in accordance with the embodiments herein. For example, the system 100 provided by the embodiments herein may be configured on a smart phone or may be PDA accessible (i.e., through communication device 104). Additionally, secure text messaging is provided, and the system 100 can be integrated with EMR 316 to allow physician/patient to access records and schedules.

Personal health records (PHR) can also be stored and accessed by the system 100 provided by the embodiments herein. Here, messaging can be integrated into ones own PHR. Additionally, this may be implemented as follows: each hospital has kiosks 326 in the lobby or other location (or may be remotely accessed) where a patient 102 can download (physician/healthcare provider approved records) of the patient 102; i.e., cat scans, blood tests, pathology, etc. The records can be stored on any appropriate data storage system 11, 204, which can be accessed by the interactive system 100 provided by the embodiments herein.

Accordingly, the embodiments herein provide a mechanism that saves time for the physicians/healthcare providers 110 while helping to deliver better healthcare to patients 102 and enhance communication with both patients 102 and/or the patient's friends/family, and accordingly is highly desirable for both physicians/healthcare providers 110 and patients 102. Moreover, the communicative tool provided by the embodiments herein allows physicians 110 and patients 102 to communicate better on their own schedules and terms and thus is an attractive solution to everyone involved.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A method of performing communication between a healthcare provider and a patient by accessing a communication server, wherein said communication server comprises a healthcare provider module, a patient module, and a database, wherein said patient registers and accesses said patient module, wherein said healthcare provider registers and accesses said healthcare provider module, wherein said database comprises information associated with said patient and said healthcare provider, said method comprising:
processing an agreement of said patient to access a message from said database;
providing a list of authorized individuals being granted permission to access said a messages from said database associated with said communication server;
communicating an identification code to said patient and to said authorized individuals; and
displaying a mailbox interface associated with said patient module to said patient on said identification code being entered, wherein said message is accessed on-demand from said patient module, wherein said message is accessed by any of said patient and said authorized individuals.

2. The method of claim 1, wherein said patient communicates with said healthcare provider using any of a video message and a text message, and wherein said healthcare provider communicates with any of said patient and said authorized individuals using any of a video message and a text message.

3. The method of claim 1, wherein said healthcare provider sends said message to said patient through a video input mechanism operatively connected to any of a portable and stationary communication device.

4. The method of claim 1, wherein said patient sends and receives said message to or from a plurality of healthcare providers.

5. The method of claim 1, wherein said patient communicates said messages to said healthcare provider using at least one of a portable and stationary communication device.

6. The method of claim 1, wherein said communication server provides a forum for said healthcare provider to communicate with any of said patient, said authorized individuals, and other healthcare providers in real time.

7. The method of claim 6, wherein said forum comprises video conferencing, means for searching said other healthcare providers by at least one of a name and a keyword associated with said other healthcare providers, and means for obtaining second opinions from said other healthcare providers, wherein said healthcare provider engages with said other healthcare providers, said patient, and said authorized individuals through said communication server.

8. The method of claim 1, wherein said communication server allows for any of said patient, said healthcare provider, and said authorized individuals to search for a particular disease in said database.

9. The method of claim 1, wherein said communication server integrates electronic medical records (EMR) of said patient to allow said healthcare provider, said patient, and said authorized individuals access records and schedules associated with said EMR.

10. The method of claim 1, wherein said messages are integrated with personal health records (PHR) associated with said patient and said healthcare provider.

11. The method of claim 1, wherein said communication server communicates healthcare provider approved records of said patient at a hospital, wherein said patient accesses said healthcare provider approved records.

12. A program storage device readable by computer, and comprising a program of instructions executable by said computer to perform a method of performing communication between a healthcare provider and a patient by accessing a communication server, wherein said communication server comprises a healthcare provider module, a patient module, and a database, wherein said patient registers and accesses said patient module, wherein said healthcare provider registers and accesses said healthcare provider module, wherein said database comprises information associated with said patient and said healthcare provider, said method comprising:
processing an agreement of said patient to access a message from said database;
providing a list of authorized individuals being granted permission to access said a messages from said database associated with said communication server;
communicating an identification code to said patient and to said authorized individuals; and
displaying a mailbox interface associated with said patient module to said patient on said identification code being entered, wherein said message is accessed on-demand from said patient module, wherein said message is accessed by any of said patient and said authorized individuals.

13. The program storage device of claim 12, wherein said patient communicates with said healthcare provider using any of a video message and a text message, and wherein said healthcare provider communicates with any of said patient and said authorized individuals using any of a video message and a text message.

14. The program storage device of claim 12, wherein said healthcare provider sends said message to said patient through a video input mechanism operatively connected to any of a portable and stationary communication device.

15. The program storage device of claim 12, wherein said patient sends and receives said message to or from a plurality of healthcare providers.

16. The program storage device of claim 12, wherein said patient communicates said messages to said healthcare provider using at least one of a portable and stationary communication device.

17. The program storage device of claim 12, wherein said communication server integrates electronic medical records (EMR) of said patient to allow said healthcare provider, said patient, and said authorized individuals access records and schedules associated with said EMR.

18. The program storage device of claim 12, wherein said messages are integrated with personal health records (PHR) associated with said patient and said healthcare provider.

19. The program storage device of claim 12, wherein said communication server communicates healthcare provider approved records of said patient at a hospital, wherein said patient accesses said healthcare provider approved records.

20. A communication tool comprising:
a healthcare provider module accessible by at least one healthcare provider that is registered to access said healthcare provider module; and
a patient module accessible by at least one of a patient and authorized individuals that is registered to access said patient module, wherein any of said patient and said authorized individuals access said patient module using an identification code to access said patient module,
wherein said healthcare provider module provides means for inputting healthcare provider messages and receiving any of patient messages and authorized user messages, and
wherein said patient module provides means for receiving said healthcare provider messages and inputting any of patient messages and authorized user messages.
